(19) United States
(12) Patent Application Publication
(10) Pub. No.: US 2012/0278827 A1
(43) Pub. Date: Nov. 1, 2012

(54) Method for Personalized Video Selection

(75) Inventors: Barry A. Kritt, Raleigh, NC (US); Sarbajit K. Rakshit, Austin, TX (US)

(73) Assignee: INTERNATIONAL BUSINESS MACHINES CORPORATION, Armonk, NY (US)

(21) Appl. No.: 13/416,673

(22) Filed: Mar. 9, 2012

Related U.S. Application Data
(63) Continuation of application No. 13/094,333, filed on Apr. 26, 2011.

(51) Int. Cl. H04N 21/24

(52) U.S. Cl. 725/14

(57) ABSTRACT

Methods in which image metadata identifying video objects in video data files is recorded; access to video data files by an end user of an access device is monitored; and a record of the concentration of personal video preferences is compiled from the monitored accesses and the image metadata of the video data files accessed by the end user. This record is then used to create summarizations of videos considered for prospective viewing by an end user and/or to select commercial messages such as advertisements to be delivered to the end user.

### PRIOR RELATED APPLICATION

This application is continuation of prior copending application Ser. No. 13/094,333 filed Apr. 26, 2011, the priority of which is claimed.

### FIELD AND BACKGROUND OF INVENTION

End users of devices capable of accessing video data files such as television programs, movies, YouTube files and other video data files accessible to devices such as personal computer systems, smartphones and the like frequently wish to view, in full, those files which will have particular interest to them. On the other side of the distribution of such materials, those who create or support the distribution of such video files may wish to deliver to an end user commercial messages tailored to the tastes of the particular individual user. What is here described addresses both the desires of the end user and the desires of the creator or distributor of video data files.

### SUMMARY OF THE INVENTION

What is here described provides that image metadata identifying video objects in video data files is to be recorded; access to video data files by an end user of an access device is monitored; and a record of the concentration of personal video preferences is compiled from the monitored accesses and the image metadata of the video data files accessed by the end user. This record is then used to create summarizations of videos considered for prospective viewing by an end user and/or to select commercial messages such as advertisements to be delivered to the end user. Methods for accomplishing this purpose are disclosed.

### BRIEF DESCRIPTION OF DRAWINGS

Some of the purposes of the invention having been stated, others will appear as the description proceeds, when taken in connection with the accompanying drawings, in which:

FIG. 1 is an illustration of a information handling system such as would be support the use by an end user exercising the invention described here;

FIG. 2 is a flow chart illustrating one sequence of steps in accordance with this invention;

FIG. 3 is a flow chart illustrating an alternate sequence of steps in accordance with this invention;

FIG. 4 is a schematic illustration of the recognition of objects within a video data file frame;

FIG. 5 is a representation of the manner of compiling, from the monitored accesses of and end user device and the image metadata of the video data files accessed by the end user, a record of the concentration of the personal video preferences of the end user;

FIG. 6 is a representation of the manner of producing from a video data file a summarized video data file which clusters together video objects correlated to the end user's record of the concentration of personal video preferences;

FIG. 7 is a flow chart depiction of the manner of producing and displaying a summarized video data file; and

FIG. 8 is a representation of a tangible computer readable storage medium having computer readable program code embodied therewith.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

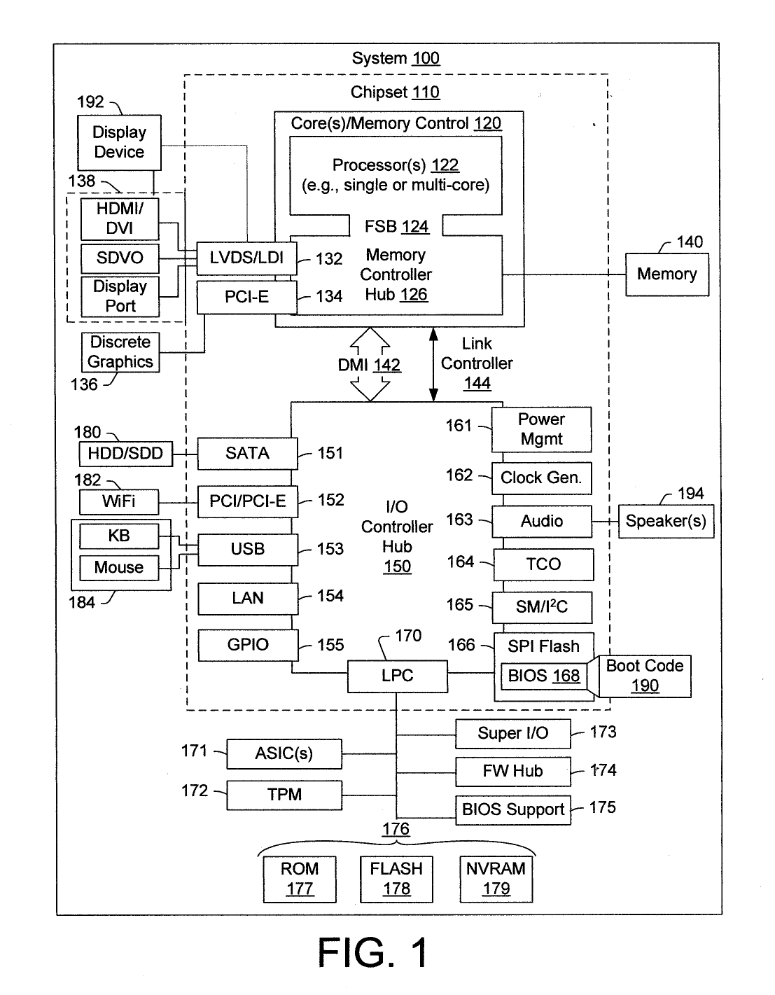

While various exemplary circuits or circuitry are discussed, FIG. 1 depicts a block diagram of an illustrative exemplary computer system 100. The system 100 may be a desktop computer system or a workstation computer; however, as apparent from the description herein, a client device, a server or other machine may include other features or only some of the features of the system 100. In the context of what is here described, the system is an information handling system which supports the distribution of video files to end user devices such s a personal computer system, smartphones and the like and thus may be considered to be more of a server.

The system 100 of FIG. 1 includes a so-called chipset 110 (a group of integrated circuits, or chips, that work together, chipsets) with an architecture that may vary depending on manufacturer (e.g., INTEL®, AMD®, etc.). The architecture of the chipset 110 includes a core and memory control group 120 and an I/O controller hub 150 that exchange information (e.g., data, signals, commands, etc.) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (e.g., single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (e.g., to provide support for a type of RAM that may be referred to as “system memory”). The memory controller hub 126 further includes a LVDS interface 132 for a display device 192 (e.g., a CRT, a flat panel, a projector, etc.). A block 138 includes some technologies that may be supported via the LVDS interface 132 (e.g., serial digital video, HDMI/DVI, display port). The memory controller hub 126 also includes a PCI-express interface (PCI-E) 134 that may support discrete graphics 136. In FIG. 1, the I/O hub controller 150 includes a SATA interface 151 (e.g., for HDDs, SDDs, etc.), a PCI-E interface 152 (e.g., for wireless connections 182), a USB interface 153 (e.g., for input devices 184 such as keyboard, mice, cameras, phones, storage, etc.), a network interface 154 (e.g., LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (e.g., for speakers 194), a TCO interface 164, a system management bus interface 165, and SPI Flash 166, which can include BIOS 168 and boot code 190. The I/O hub controller 150 may include gigabit Ethernet support.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168. As described herein, a device may include fewer or more features than shown in the system 100 of FIG. 1.

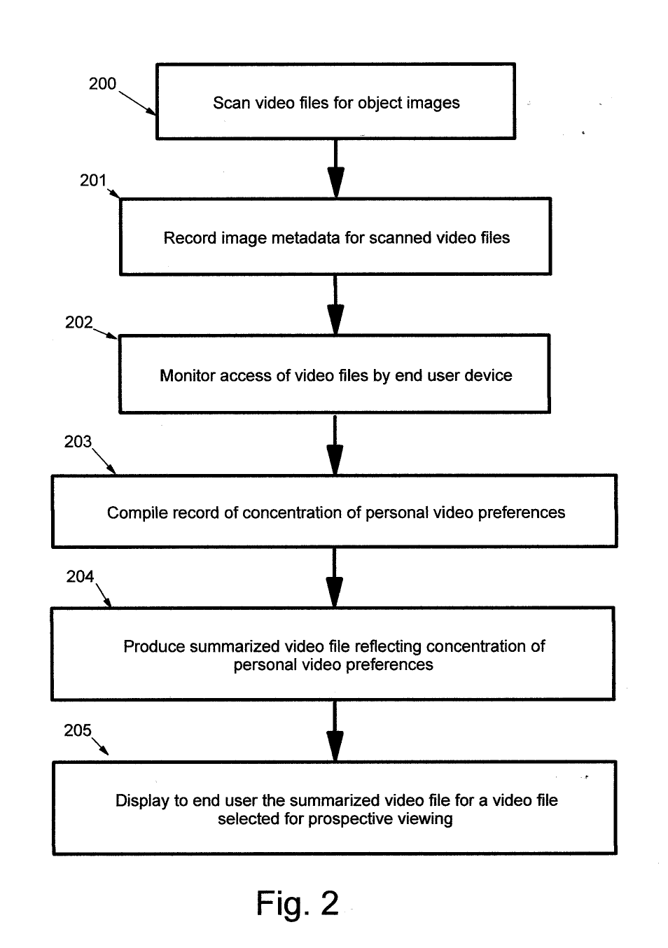

Turning now to FIGS. 2 through 7, what is described relates to identifying an end user's preference for certain video images, over multiple viewings and/or over the passage of time and then using that information to shape video displayed to that particular user. The video—which may be a timed sequence of frames such as is experienced as a moving picture, a slide show of sequenced still images, or even a single selected image—is personalized to the individual viewing habit of the individual end user. The viewing habits may be determined on the basis of human individuals selected for viewing (musicians, actors, politicians, entertainers or the like) or on the basis of objects selected for viewing (such as boats, airplanes, golf equipment, other sports equipment or the like) or on the basis of distinctive colors or color combinations (such a team colors for athletic teams) or on the basis of the time of viewing (day, hour or both). The viewing habits may involve more than one of these criteria or all.

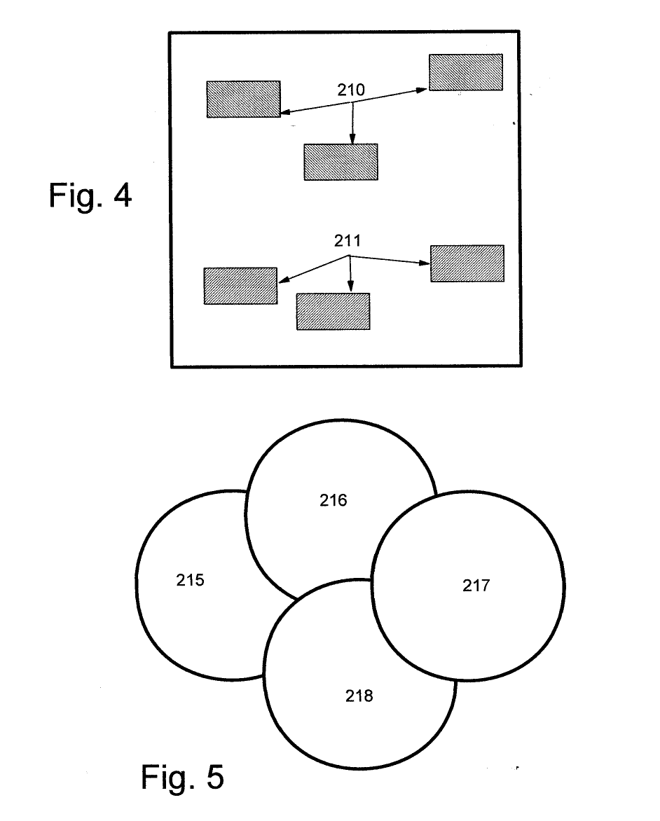

In preparation for such determination, video data files are scanned for object images (200 in FIG. 2). The technology for recognition of video objects such as faces (210 in FIG. 4), various things (211 in FIG. 4), and colors are known and will be employed in such scanning. The scanning produces metadata for video image files, identifying the various objects found therein, which is recorded (201 in FIG. 2). The fields of metadata for four video image files 215, 216, 217 and 218 are shown as circles in FIG. 5

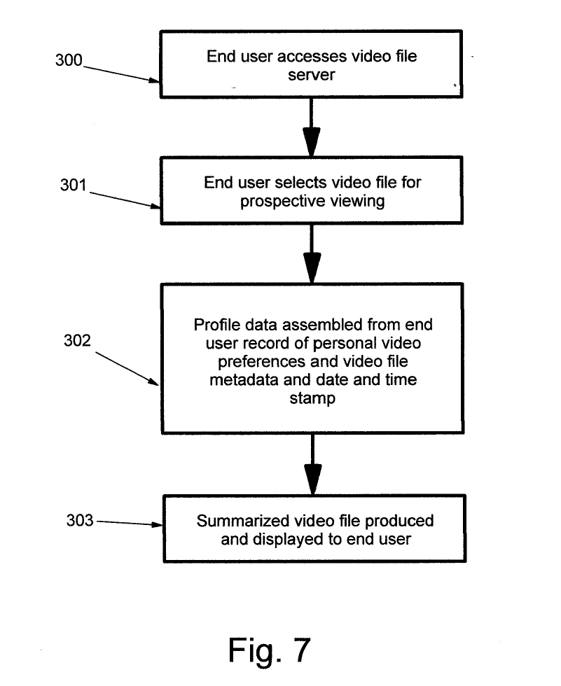

When an end user, employing any end user device capable of accessing video data files such as a personal computer system or a smartphone, accesses video data files, that access is monitored (202 in FIG. 2). Over time, a record is compiled of that end user's concentration of personal video preferences (203 in FIG. 2). That concentration is determined by the overlapping of the fields of meta data in a plurality of video data files access by the end user, in FIG. 5. While only four fields are shown in FIG. 5 for purposes of simplifying the illustration, it will be understood that, over time, many such overlapping fields of metadata will be found and a long term record developed. With date and time stamping of user access records (302 in FIG. 7), the record may be selectively shaped to consider shifting interests of the end user over the passage of time.

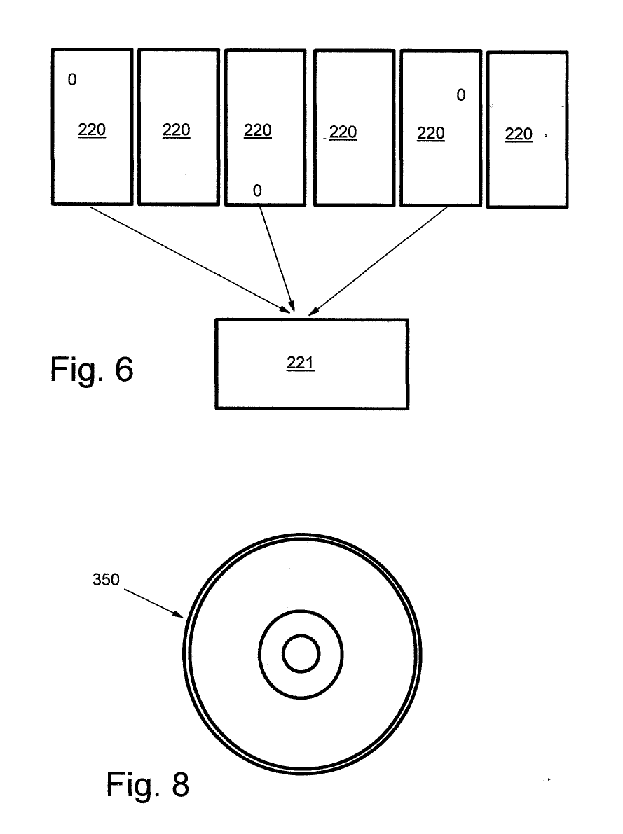

With the compiled record of end user interest developed, then that record is used to produce a summarized video (FIGS. 6 and 7). That is, a video data file which the end user is considering for full viewing is summarized in a shorter length file into which elements known from the user's concentration of personal video preferences are brought together. In FIG. 6, such elements are indicated in the first, third and fifth frames 220 (counting from left to right) of a video data file. These frames are then chosen for inclusion into the summarized video data file 221. FIG. 7 illustrates the flow of steps in producing and displaying such a summarized video file.

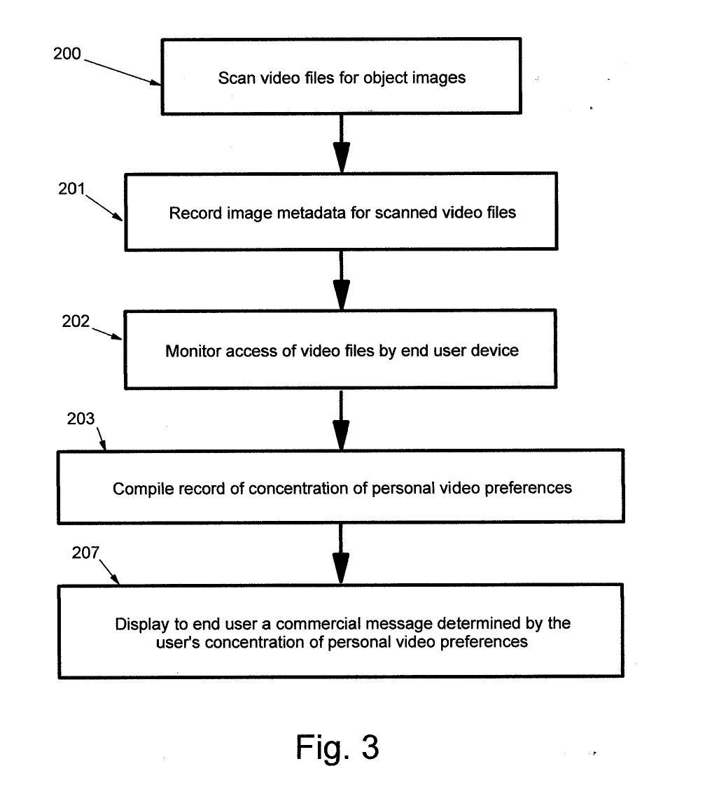

Returning to FIG. 3, a contemplated alternative is the use of the compiled record of end user interest to select a commercial message determined form that record to be of possible interest to the end user and display that message to the user (207 in FIG. 3). The preceding steps in the flow of FIG. 3 are identified for simplification and clarity with the same reference characters used in FIG. 2.

One or more aspects of the present invention can be included in an article of manufacture (e.g., one or more computer program products) having, for instance, tangible computer usable media, indicated at 350 in FIG. 8. The media has embodied therein, for instance, computer readable program code for providing and facilitating the capabilities of the present invention. The article of manufacture can be included as a part of a computer system or sold separately. Machine readable storage mediums may include fixed hard drives, optical discs such as the disc 350, magnetic tapes, semiconductor memories such as read only memories (ROMs), programmable memories (PROMs of various types), flash memory, etc. The article containing this computer readable code is utilized by executing the code directly from the storage device, or by copying the code from one storage device to another storage device, or by transmitting the code on a network for remote execution.

In the drawings and specifications there has been set forth a preferred embodiment of the invention and, although specific terms are used, the description thus given uses terminology in a generic and descriptive sense only and not for purposes of limitation.

What is claimed is:

1. Method comprising:
recording image metadata identifying video objects in video data files;
monitoring access to video data files by an end user of an access device; and
compiling from the monitored accesses and the image metadata of the video data files accessed by the end user a record of the concentration of personal video preferences.

2. Method according to claim 1 further comprising determining from the compiling of the monitored accesses and the image metadata of the video data files the character of the video objects accessed by the end user.

3. Method according to claim 2 wherein the character of the video objects accessed by the end user is at least one of images of humans and images of things.

4. Method according to claim 1 further comprising determining from the compiling of the monitored accesses and the image metadata of the video data files the concentration of personal video preferences across a plurality of distinct video data files.

5. Method according to claim 4 wherein the determining of the concentration of personal video preferences comprises analyzing the overlap of image metadata across the plurality of distinct video files.

6. Method according to claim 1 further comprising determining from the compiling of the monitored accesses and the image metadata of the video data files the concentration of personal video preferences across a plurality of distinct times of user access.

7. Method according to claim 1 further comprising producing from a video data file a summarized video data file clustering together video objects correlated to the user's record of the concentration of personal video preferences.

8. Method according to claim 7 wherein the producing of a summarized video data file is in response to user selection of a video data file for prospective viewing and further comprising displaying to the user the summarized video data file.

9. Method according to claim 1 further comprising delivering to the user a commercial message determined by the user's record of the concentration of personal video preferences.
